(19) United States
(12) Patent Application Publication
(10) Pub. No.: US 2004/0049714 A1
(43) Pub. Date: Mar. 11, 2004

(54) Detecting errant conditions affecting home networks

(76) Inventors: David J. Marples, Mansfield (GB); Christopher Brightman, Leicestershire (GB); Abhrajit Ghosh, Scotch Plains, NJ (US); Stanley L. Moyer, Mendham, NJ (US); Simon Tsang, Jersey City, NJ (US)

Correspondence Address: TELCORDIA TECHNOLOGIES, INC., ONE TELCORDIA DRIVE 5G116, PISCATAWAY, NJ, 08854-4157, US

(21) Appl. No.: 10/235,199

(22) Filed: Sep. 5, 2002

(51) Int. Cl. G06F 11/30

(52) U.S. Cl. 714/43

(57) ABSTRACT

Errant conditions, including configuration issues, device/application failures, and performance problems, affecting a home network are detected by considering end-to-end information flows within the home network and between the home network and an external network. Specifically, errant conditions are detected by analyzing monitored network information flows, by analyzing responses resulting from the active stimuli of hardware/software components within the home and external network, and by considering in this analysis configuration information obtained from network devices. Gathered information and detected errant conditions are reported to an administrative management system for further analysis and for use by a help-desk administrator or home user in resolving the reported conditions.

### BACKGROUND OF OUR INVENTION

1. Field of the Invention

Our invention relates generally to detecting errant conditions that affect the home network. More particularly, our invention relates to detecting errant conditions through the end-to-end information flows of the home network.

2. Description of the Background

Consumers have traditionally connected to an ISP (Internet service provider) and the Internet using a personal computer and an Internet access device, such as a standard modem. However, with the advent of broadband Internet access, such as cable and DSL (digital subscriber loop), consumers are now building complex home networks. FIG. 1 shows an exemplary home network 102 comprising an Internet access device 104 (such a cable modem or DSL modem) and a plurality of network devices, including a gateway router 106, one or more personal computers (PC) 108, a laptop 110, printers/print server 112, etc. The Internet access device 104 provides interconnectivity between the home network 102 and ISP network 120/Internet 122. The gateway router 106 can provide a plurality of functions including firewall functionality, switching functionality to interconnect the network devices 108, 110, and 112, router functionality to interconnect the network devices 108, 110, and 112 to ISP 120, network address translation (NAT) functionality to allow the plurality of network devices 108, 110, and 112 to connect to ISP 120 using a single public IP (Internet protocol) address, DHCP (dynamic host configuration protocol) functionality to configure network devices 108 and 110, etc.

In these newer home networks, information related to applications/services flows between the network devices (such as intra-network file sharing), from the network devices to the Internet (such as Web browsing), and from the Internet to the network devices (such as Web hosting). Unlike the original home configuration that simply required the internet access device and PC to be configured, the proper and efficient functioning of these applications/services in the newer home network now requires the network as a whole be configured to ensure all network devices properly inter-work. A primary issue however is that consumers do not understand and/or have no desire to understand the details of home network configuration and operation, thereby leading to errors.

As a result, equipment vendors have developed solutions that can assist consumers in configuring their home networks; however, these solutions only assist the consumers in configuring specific individual devices. For example, manufacturers of gateway routers and PCs provide tools to assist consumers in configuring that specific device. While these tools function well in configuring an individual device, they do not examine the network as a whole and fail to recognize that in a networked environment, network devices must properly inter-work in order for network-based-services, like those previously described, to properly operate. Specifically, because these prior solutions are limited to a single device, they do not examine the end-to-end operation of the network and fail to account for the other network devices that may affect proper operation. For example, multiple devices on a single network create the possibility of IP address conflicts, an issue that is not likely to be detected by analyzing IP addresses on a per device basis. Similarly, intercommunication among the network devices, using NetBIOS for example, requires that each network device be configured with a unique name and that the other network devices know this name and the name's spelling as configured. Further, a PC performing Web server functions requires not only proper PC configuration, but also requires proper port forwarding configurations with respect to NAT functionality on the gateway router. In each of these examples, although an individual device may appear properly configured, other network devices may affect proper network operation leading to undetected errors. The result is that consumers often contact their ISP or the manufacturers of the network devices for assistance when home networking issues arise. However, the ISP and manufacturers have limited capability to assist the consumer because they only have direct control over individual segments/devices of the home network and not the home network as a whole.

### SUMMARY OF OUR INVENTION

Accordingly, it is desirable to provide methods and systems that consider the entire home network at once, rather than individual devices in isolation, to detect errant conditions affecting the home network. Specifically, in accordance with our invention, errant conditions, including configuration errors, performance issues, and network device/application failures, are detected by considering the end-to-end information flows both within the home network and between the home network and an external network. More particularly, errant conditions affecting the home network are detected by monitoring information flows within the home network and to/from the network, by actively stimulating hardware/software components both within the home and external network for stimuli responses, and by obtaining configuration information from home network devices, which information is used in combination with the information gathered through monitoring and stimulation in detecting/solving errant conditions. By passively monitoring and actively stimulating the home and external network, our inventive system analyzes the interactions of the home network devices/applications among themselves and with the external network, and analyzes any given device/application from the standpoint of how other network devices/applications will interact with this any given device/application.

Our inventive system comprises an administrative agent that resides within each home network and an administrative management system that resides within an external network or alternatively, within each home network. The administrative agent comprises a passive monitor analysis agent for passively monitoring the network information flows, an active stimuli analysis agent for stimulating the hardware/software components for stimuli responses, and a configuration inspection analysis agent for obtaining the network configuration information. The passive monitor analysis agent and active stimuli analysis agent may analyze the gathered information, along with the information gathered by the configuration inspection analysis agent, to detect errant conditions, which conditions are reported to the administrative management system. Alternatively, the agents may pass all or a subset of the gathered information to the administrative management system, where the information is further analyzed for errant conditions.

The administrative management system maintains a database of detected errant conditions, which, as indicated, are either directly detected by the administrative agent or are the result of the administrative management system further analyzing the information gathered by the administrative agent. When the administrative management system resides within the home network, our inventive system is specific to that consumer and only maintains/analyzes errant conditions specific to that consumer/home network. When the administrative management system resides external to the home network, our inventive, system maintains/analyzes errant conditions for a plurality of home networks. Here, a help desk administrator uses the system to assist consumers in resolving errant conditions affecting their home networks.

### BRIEF DESCRIPTION OF THE DRAWINGS

FIG. 1 depicts an exemplary customer home network, to which our invention is applicable, the network including a plurality of network devices that require proper configuration for network services and applications to properly and efficiently function.

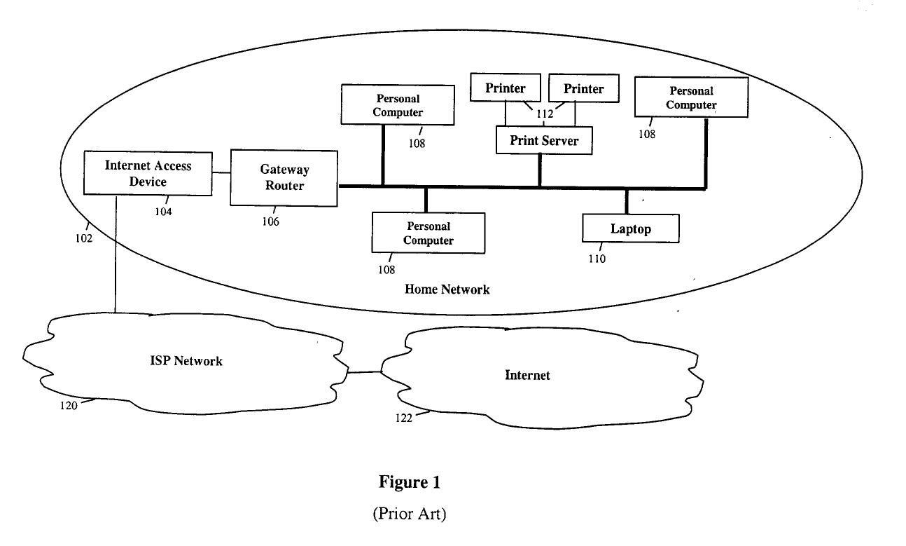

FIG. 2 depicts an illustrative embodiment of our inventive home network administration system, which detects errant conditions affecting the home network by considering the end-to-end information flows within the home network through passive monitoring of network device interactions and through active stimulating of network devices and applications.

FIG. 3 is an exemplary passive monitoring module in accordance with our invention that examines NetBIOS session request and session response messages in order to detect NetBIOS naming errors.

FIG. 4 is an exemplary passive monitoring module in accordance with our invention that examines IP messages in order to detect network devices within the home network that have misconfigured IP addresses.

FIG. 5 is an exemplary passive monitoring module in accordance with our invention that examines ICMP (Internet control message protocol) and TCP (transmission control protocol) messages in order to detect port forwarding misconfigurations on a NAT enabled gateway router.

FIG. 6 is an exemplary stimulating module in accordance with our invention that monitors applications executing within the home network to ensure these applications are executing and to ensure that these applications can be communicated with by internal/external devices, which monitoring is performed by periodically stimulating the applications with request messages and by examining the responses.

FIG. 7 is an exemplary stimulating module in accordance with our invention that assures a gateway router based DHCP server is the only DHCP server running in the home network and that this DHCP server is properly functioning, which assurances are performed by periodically broadcasting DHCP-discover messages and by examining the DHCP-offer response messages.

FIG. 8 is an exemplary stimulating module in accordance with our invention that monitors the performance of the home and external networks by periodically sending DNS (domain name server) requests to a DNS server run by an ISP and by examining the response times.

### DETAILED DESCRIPTION OF OUR INVENTION

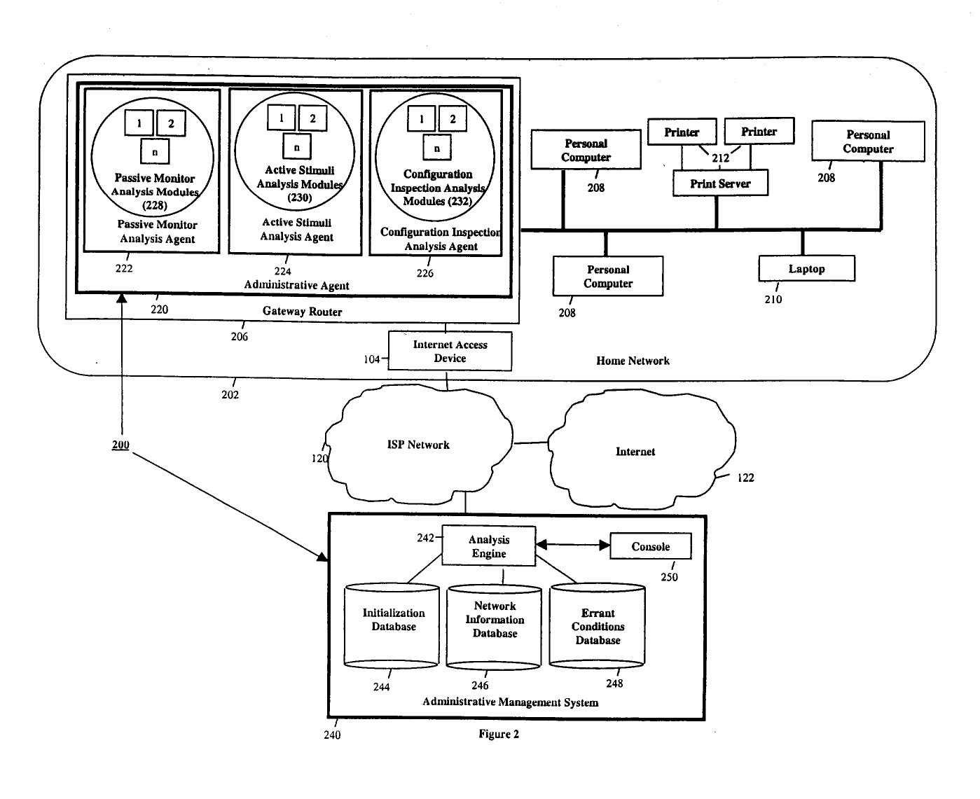

FIG. 2 shows a block diagram of home network administration system 200 of our invention that detects errant conditions affecting home network 202 by considering the end-to-end information flows both within the home network and between the home network and Internet 122. As compared to prior systems, which are directed at detecting network configuration errors by considering the specific configurations of individual network devices, our inventive system and methods detect errant conditions affecting the home network, including network device configuration errors, by considering the information flows within the home network.

System 200 comprises administrative agent 220 that resides within each home network 202 and an administrative management system 240 that preferably resides external to the home network, such as within a third-party's network or an ISP's network 120 (as shown in FIG. 2), but alternatively, may also reside within each home network 202. Broadly, the administrative agent 220 detects errant conditions within the home network 202 by passively monitoring network communications both within the network and to/from the network, by actively stimulating hardware/software components both within the home network and outside the network, and by obtaining configuration information from the network devices 206, 208, 210, and 212, which information is used in combination with the information gathered through monitoring and stimulation to assist in detecting/solving errant conditions. In general, the administrative agent 220 transfers the gathered information and detected errant conditions to administrative management system 240.

Administrative management system 240 maintains a database of detected errant conditions, which conditions are either directly detected by the administrative agent 220 or are the result of the administrative management system 240 further analyzing the information gathered by the administrative agent 220. When the administrative management system 240 resides within the home network, system 200 is specific to that consumer and only maintains/analyzes errant conditions specific to that consumer/home network. Here, the administrative management system 240 may directly report detected errant conditions to the consumer through, for example, a window on a PC. Likewise, the consumer may access the system 240 to obtain detected errant conditions. When the administrative management system 240 resides external to the home network, such as within the ISP's network, system 200 maintains/analyzes errant conditions for a plurality of home networks (unless otherwise noted, the remainder of this discussion assumes the administrative management system resides within an ISP's network). Here, a single administrative management system 240 services a plurality of home networks/administrative agents 220. The administrative management system 240 may alert an ISP administrator of detected errant conditions such that the administrator can, for example, proactively reconfigure a consumer's home network 202 (or notify the consumer to perform the reconfiguration). Similarly, an administrator can use system 240 to understand the state of a consumer's home network and thereby better assist the consumer in resolving network related configuration issues, device/application failures, performance problems, etc. An advantage of the administrative management system 240 being located within the ISP's network is that the ISP gains a broad view of both its network and all consumer networks, allowing the ISP to detect network issues both within a particular consumer's network and also within its own network.

Reference will now be made to system 200 in greater detail, beginning with administrative agent 220 and then with administrative management system 240. Administrative agent 220 comprises a passive monitor analysis agent 222, an active stimuli analysis agent 224, and a configuration inspection analysis agent 226. These analysis agents 222, 224, and 226 are software-based modules and collectively reside within a single device within the home network 202 or are distributed across several devices within the home network. The device(s) that execute the agents are either dedicated to this purpose or, preferably, are an existing device(s) within the network, such as a PC 208 and/or the gateway router 206 (as shown in FIG. 2).

The passive monitor analysis agent 222 passively monitors all data packets flowing through network 202 and to/from network 202, and filters and analyzes certain packets for errant conditions. By passively monitoring network 202, agent 222 analyzes the interactions of the network devices 206, 208, 210, and 212 among themselves and with the external network. The active stimuli analysis agent 224 actively stimulates network devices and software applications both within and external to home network 202 and analyzes the stimuli responses for errant conditions. Through active stimuli, agent 224 analyzes a device/application from the standpoint of how other network devices will interact with this device/application. The configuration inspection analysis agent 226 gathers configuration information from the network devices 206, 208, 210, and 212, which information is used in combination with the information gathered by the other agents 222 and 224 in order to detect errant conditions.

As further described below, each agent 222, 224, and 226 further comprises a plurality (1 . . . n) of software-based modules 228, 230, and 232 respectively, each module directed at detecting and analyzing a particular errant condition or gathering certain information. Which modules actually comprise a given agent depends on the agent configuration as specified by the administrative management system 240. Specifically, when the agents 222, 224, and 226 initialize, they access an initialization database at the administrative management system 240 and determine which modules they should execute.

In general, as an agent module gathers network related information corresponding to its directed purpose, the module passes some form of this information to the administrative management system 240. The amount and type of information an agent module passes to the administrative management system 240 depends on the module's function and on the amount of analysis the module performs. For example, complete analysis of an errant condition may require information gathered by another agent module, such as configuration information gathered by a configuration inspection analysis module. An agent module may be able to completely detect an errant condition if such configuration information is stored locally in administrative agent 220. However, given the amount of information the administrative agent 220 may collect, it may not be possible to locally store all gathered information and, as a result, it may be more feasible for an agent module to pass raw information or only an initial indication of a possible errant condition back to administrative management system 240 and then allow administrative management system 240 to complete the analysis. In general, an agent module and/or the administrative management system 240 can perform the analysis to detect an errant condition and the exact location where information is analyzed is independent from our invention. What is important to our invention is the analyzing of end-to-end information flows through passive monitoring and active stimulation in order to detect errant conditions within the home network. Several exemplary agent modules 228, 230, and 232 are presented below and for ease of description, are described as though the analysis of errant conditions that each detects is performed completely within the administrative agent 220. However, as indicated, nothing precludes the functions performed by these modules from residing in both the administrative agent 220 and the administrative management system 240.

Turning to administrative management system 240, this system comprises an analysis engine 242, an initialization database 244, a network information database 246, an errant conditions database 248, and a console 250 (note that console 250 represents a PC-based window, for example, when the administrative management system resides within home network 202). The initialization database 244 comprises a set of configuration parameters for configuring the administrative agent 220 within each home network 202. When a home network first initiates communications with the ISP and the administrative agent 220 initializes, each agent 222, 224, and 226 accesses configuration information from the initialization database 244 and uses the information to determine the types of agent modules 228, 230, and 232 it should execute (i.e., the types of errant conditions the agents should attempt to detect).

Network information database 246 maintains the information gathered and reported by the administrative agent 220 for each home network. Again, this information can include raw information, initial indications of possible errant conditions, or indications of actual errant conditions. The errant conditions database 248 maintains specific errant conditions detected within a given home network, which errant conditions are placed in the database by the analysis engine 242. Specifically, as agent modules 228, 230, and 232 place information into the network information database 246, the analysis engine 242 analyzes the information further. If an agent places an actual errant condition in the database, the analysis engine transfers this condition to the errant conditions database 248. However, if an agent places an initial indication of a possible errant condition in the database, the analysis engine may further analyze the condition using other information in the database before making an indication of an errant condition in the errant conditions database 248.

In addition to analyzing errant conditions, the analysis engine 242 may also report detected errant conditions to console 250 such that an ISP help-desk administrator can proactively assist a consumer. A help-desk administrator can also access the errant conditions database 248 and the network information database 246 in order to assist a consumer in resolving a home network issue.

In general, as compared to prior systems that administer the home network by examining the specific configurations of individual network devices in isolation, our inventive home network administration system 200 administers the end-to-end home network by examining the interactions of the home network devices with themselves and the external network. Uniquely, our inventive system performs this administration by monitoring the end-to-end information flows among the network devices and among these devices and the external network and by stimulating/probing network devices from the standpoint of other network devices. Our system also combines this information with general network device configuration information and states. Overall, by examining network flows and network stimuli, our inventive system obtains network information related to the whole network at one time, as compared to piece-parts, making it easier for a consumer or help-desk administrator to diagnose a configuration problem, a device failure, an application failure, a performance problem, etc.

Reference will now be made to the administrative agent 220 in greater detail, in particular, to exemplary administrative agent modules 228, 230, and 232. Beginning with the configuration inspection analysis agent 226, this agent gathers configuration information from the network devices 206, 208, 210, and 212 and makes this information available to the passive monitor analysis agent 222 and active stimuli analysis agent 224 and/or stores this information in network information database 246. Again, the passive monitor analysis agent and active stimuli analysis agent may use the network device configuration information to detect specific errant conditions. Similarly, an ISP help-desk administrator, for example, may use the information to help resolve a detected errant condition. Different configuration inspection analysis modules 232 gather different configuration information, and which modules are executing is dependent upon initialization information as obtained from the initialization database 244.

Several exemplary configuration inspection analysis modules are now described. A first exemplary module is one that determines gateway router 206's assigned IP address on home network 202 and the subnet mask of the home network. If the gateway router is running a DHCP server, this information can be obtained by sending a DHCP request to the server. Otherwise, the information can be obtained by using standard interfaces provided by the router.

A second exemplary module is one that obtains the gateway router's port forwarding tables, assuming the router supports NAT functionality. Typically, there is a TCP-port-forwarding table and an UDP-port-forwarding table, both of which can be obtained from the gateway router using standard interfaces.

A third exemplary module is one that determines the set of active devices on home network 202, which determination can be made through an ARP (address resolution protocol) storm. Specifically, based on the subnet address of the home network (the subnet address can be determined by performing a “bit-wise and” operation between the subnet mask of the home network and the gateway router's assigned IP address), this exemplary module performs an ARP storm. During the ARP storm, this exemplary module notes the IP address in each ARP response received, the set of IP addresses thereby denoting the active devices on the network. Because devices can be added to and removed from the home network, this module may periodically execute, updating the set of active devices based on the ARP responses received during the subsequent ARP storm.

Turning to the passive monitor analysis agent 222, this agent passively monitors all data packets flowing among the network devices 206, 208, 210, and 212 and between these network devices and the external network. Based on configurable filters, the agent accepts certain packets (e.g., DNS queries and responses) for further analysis by one or more passive monitor analysis modules 228 Specifically, each passive monitor analysis module 228 monitors for a certain errant condition by setting a specific filter to gather certain packets from the network and by analyzing the packets for the errant condition. Again, which monitor modules are executing is dependent upon the passive monitor analysis agent configuration as obtained from the initialization database 244.

Before describing several exemplary passive monitor analysis modules, it should be noted that the location of the passive monitor analysis agent 222 within the home network 202 might create a monitoring issue. Specifically, as indicated above, the administrative agent 220 can reside on gateway router 206, on another device within the home network such as a PC 208, or can be distributed across several devices. In general, the location of the administrative agent 220 is not important to our invention. However, gateway routers today typically include switching functionality to interconnect the network devices 208, 210, and 212. As a result, the only traffic a given device can see is the traffic that device either originates or terminates. This creates an issue for the passive monitor analysis agent, which in general, needs to see all network traffic flowing from/to all devices. If the passive monitor analysis agent resides on gateway router 206, there is no issue because all network traffic passes through the router/switch. However, if the passive monitor analysis agent resides on a network device connected to a switched based interface, modules 228 will fail to see all network traffic.

ARP cache poisoning is one technique that can be used to resolve this issue. Under this technique, the device hosting the passive monitor analysis agent “poisons” the ARP caches of the other devices on the home network, including gateway router 206's ARP cache. Specifically, once knowing all devices on the home network (which information can be obtained by a configuration inspection analysis module as described above), the monitoring device hosting the passive monitor analysis agent 222 sends a set of ARP reply messages to each of the other devices on the home network indicating to these devices that any IP address on the local network maps to the monitoring device's physical address. The result of this poisoning is that all messages entering the home network from the gateway router or originating from a device on the home network are routed to the monitoring device. Upon receiving a message, the monitoring device forwards a copy to the passive monitor analysis module(s) 228 based on the configured filters and then modifies the message with the correct physical address and forwards the message to the correct destination. If the passive monitor analysis agent 222 runs for a prolonged period of time, the monitoring device will need to periodically perform cache poisoning as the ARP cache entries in the network devices timeout.

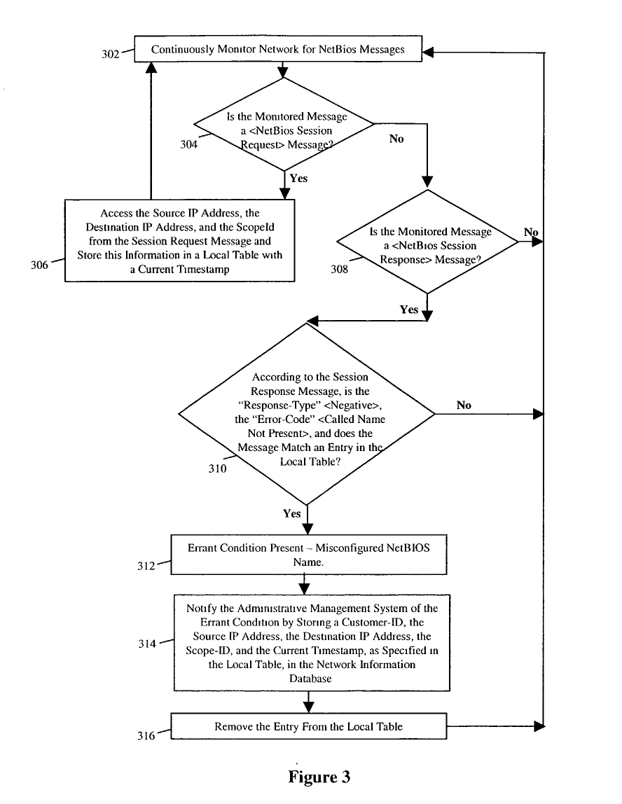

Several exemplary passive monitor analysis modules 228 are now described. A first exemplary module is one that detects NetBIOS configuration errors, for example one that detects naming configuration errors. Assume for example a first PC on home network 202 is configured to act as a Web server and its network name is misconfigured (e.g., the consumer mistypes the name when configuring the device). A second PC on home network 202 will fail to access this first server-based PC when using the correct name spelling because the connection oriented session on which the Web service is based will not establish because no network element will match the entered name. FIG. 3 shows an agent module that can assist in diagnosing and detecting this type of configuration problem. In this example, the module continuously filters NetBIOS messages and in particular, examines NetBIOS session request and session response pairs looking in particular for pairs where the session response indicates the called name was not present.

Beginning with step 302, the module continuously monitors the network for NetBIOS messages. When a message is found, the module proceeds to step 304 where the message is examined to determine if it is a “session request” message. If the received message is a session request, operation proceeds to step 306 where the message's source IP address, destination IP address, and NetBIOS scope-ID are noted in a local table along with a current timestamp. Operation then returns back to step 302 for further monitoring of the network. If in step 304 the received message is not a session request, operation proceeds to step 308 where the message is examined to determine if it is a “session response” message. If the message is not a session response, operation proceeds back to step 302. However, if the message is a session response, the message is examined in step 310 to determine if the NetBIOS “response-type” is “negative,” if the NetBIOS “error-code” is “called name not present,” and if the message matches an entry in the local table (as per the NetBIOS scopeID). If the three conditions are true, an errant condition is present, specifically, a misconfigured NetBIOS name as shown by step 312. Otherwise, operation proceeds back to step 302. When an errant condition is present, operation proceeds from step 312 to step 314 where the passive monitor analysis module 228 notifies the administrative management system 240 of the errant condition by storing in the network information database 246 a customer-ID, and the source IP address, the destination IP address, the NetBIOS scopeId, and the current timestamp as specified from the local table. The local table entry is then removed in step 316 and operation proceeds back to step 302. Note that as described earlier, the data analysis of this exemplary module can occur in the administrative agent 220 and/or the administrative management system 240, and that our invention is independent of the exact location. As such, in this example, the passive monitor analysis module could also pass all NetBIOS session request and session response messages to the administrative management system 240, where analysis engine 242 would then detect naming errors.

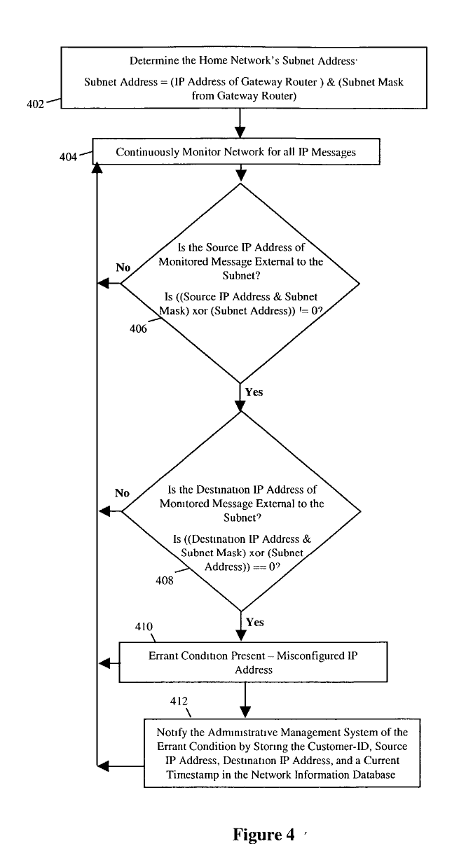

A second exemplary passive monitor analysis module is one that detects misconfigured IP addresses. Assume, for example, a consumer alternatively connects laptop 210 to either a corporate network or to the home network 202. Each time the consumer connects the laptop to the home network, the laptop's IP address must be changed in order for the laptop to properly communicate on the home network. FIG. 4 shows an agent module that can assist in detecting IP address issues. In this example, the module continuously filters all IP messages looking in particular for messages that have both a source IP address and a destination IP address external to the home network (i.e., looking for a device on the home network that is generating messages to a system external to the home network.).

Beginning with step 402, the module first determines the subnet address of home network 202 in order to determine whether a monitored IP packet is external to this network. The module can determine the subnet address of the home network by performing a “bit-wise and” operation between the subnet mask of the home network and the gateway router's assigned IP address on the home network (the subnet mask and gateway router's IP address are configuration parameters that a configuration inspection analysis module can obtain as described above).

In step 404, the module continuously monitors the network for IP messages. When a message is received, operation proceeds to step 406 where the message is examined to determine if its source IP address is external to the home subnet. This determination can be made by performing a “bit-wise and” operation between the source IP address and the network's subnet mask, which operation determines the subnet of the source IP address. This resulting value is then be compared to the subnet of the home network (as determined in step 402) by performing a “bit-wise exclusive or” operation between the two values. A non-zero resulting value indicates the source IP address has a different subnet than the home network, in which case operation proceeds to step 408 to examine the message's destination IP address. Note that if the source IP address of the message has the same subnet as home network 202, no conclusive determination can be made for the message and operation proceeds from step 406 back to 404.

Similar to the source IP address, the message's destination IP address is examined in step 408 to determine if the address has the same subnet as the home network. If the subnets are the same, no conclusive determination can be made and operation proceeds back to step 404. However, if the subnets are different, a misconfigured IP address errant condition is present (as shown by step 410) and operation proceeds to step 412 where the passive monitor analysis module notifies the administration management agent 240 of the condition by storing in network information database 246 a customer-ID, the source and destination IP addresses of the monitored message, and a current timestamp. Operation then proceeds back to step 404.

A third exemplary passive monitor analysis module is one that detects port-forwarding misconfigurations in gateway router 206 configured to perform NAT functionalities. When gateway router 206 is configured to perform these functions (i.e., the home network is using a single public IP address) and the consumer configures a local PC to act as a server (e.g., a Web server, file server, etc.) to which devices external to home network 202 should have access, the consumer must properly configure the local PC to act as a server, and must also perform static port forwarding configurations at the gateway router 206 so that the router properly reroutes received server requests to this local PC server. Incorrect NAT configurations may cause gateway router 206 to route requests to an unintended local PC. Assuming this unintended local PC is not configured to act as a server, it will generate an error message back to the external requesting device. Such error messages can be used to detect port-forwarding misconfigurations.

More specifically, any service request to a local PC server will come in the form of a UDP or TCP message designated for a specific port on the PC, on which port the intended service application is expected to be listening. When these messages reach gateway router 206, the gateway will convert the destination IP address and possibly the destination port to a local PC based on either a UDP port-forwarding table or a TCP-port-forwarding table. When an unintended local PC receives an UDP-datagram for a port on which no application is listening, the PC will generate an ICMP message back to the requesting device with the source IP address set to the PC and the destination IP address set to the external device. The PC will set the “type” field and the “error-code” field of the ICMP header to “destination unreachable” and “port unreachable,” respectively. The original UDP-datagram header is placed in the body of the ICMP message. Similarly, when an unintended local PC receives a TCP connection request for a port not in use, the PC will generate a TCP “reset” message back to the requesting device with the source IP address set to the PC, with the destination IP address set to the external device, and with the “source port-number” set to the “destination port-number” of the original TCP request. In addition, the PC will set the “type” field of the TCP header to “reset (RST).”

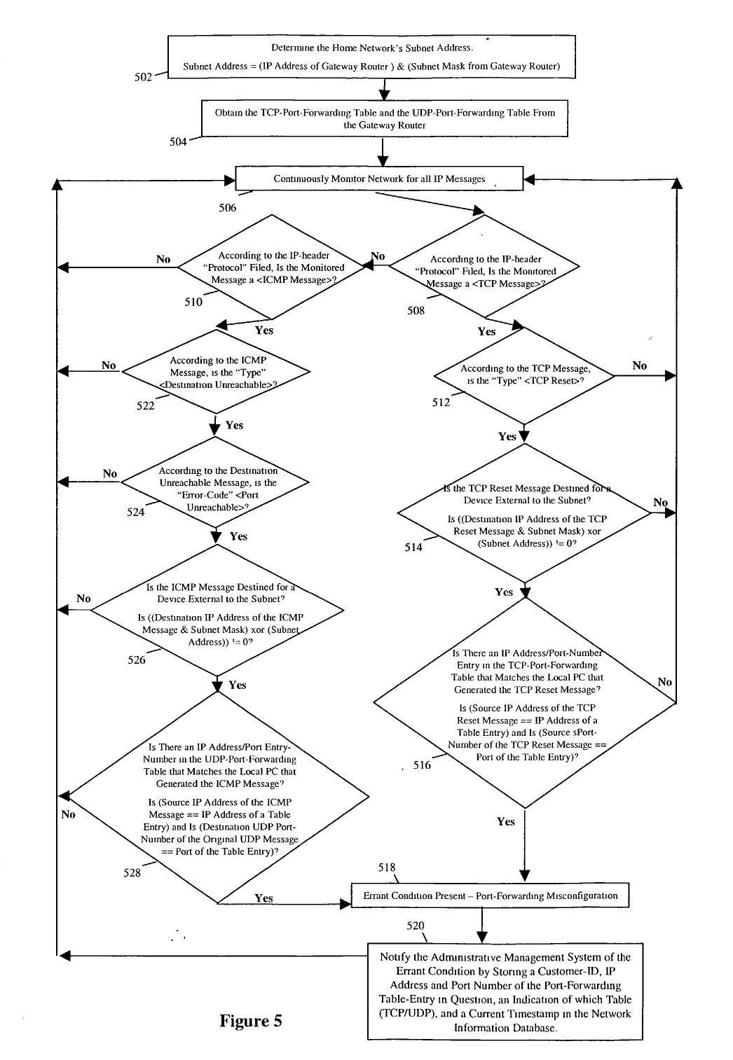

This third exemplary passive monitor analysis module uses these ICMP and TCP reset messages to help detect port-forwarding misconfigurations, as shown in FIG. 5. In this example, the module continuously filters all IP messages looking in particular for ICMP port unreachable messages and TCP reset messages that are sent from the home network 202 to the external network. Note that the generation of these messages is not a conclusive indication that there is a port forwarding misconfiguration. In other words, the port forwarding configuration may be correct such that the intended PC receives the UDP/TCP message, but the PC may be misconfigured (e.g., the intended application may not be running), which misconfiguration will also cause the generation of the ICMP and TCP reset messages. However, the active stimuli analysis agent 224, described below, can check the status of an application on a PC and when combined with this current module, can be used to diagnose potential port forwarding misconfigurations.

Turning to FIG. 5 step 502, the home network's subnet address is first determined using the same process as described above for FIG. 4, step 402. In step 504, the TCP-port-forwarding table and UDP-port-forwarding table are obtained from the gateway router using standard interfaces (alternatively, these tables can be obtained from a configuration agent module, as described above). In step 506, the module continuously monitors the network for IP messages. When a message is received, operation proceeds to step 508/510 where the IP-header “protocol” field is examined to determine if the message is TCP message (step 508) or an ICMP message (step 510). If the message is neither, operation proceeds from step 510 back to step 506.

If the message is determined to be a TCP message in step 508, operation proceeds to step 512 where the “type” field of the TCP header is examined to determine if the message is a “reset” message. If the message is not a reset, operation proceeds back to step 506. However, if the message is a reset, a determination can be made that there is misconfiguration either with the local PC (i.e., the application is not executing) or with the gateway router (i.e., a port forwarding error). However, to direct this module at detecting port forwarding errors, the module next determines in steps 514 and 516 whether the original TCP request message that triggered the detected TCP reset message passed through the gateway router. The module first makes this determination in step 514 by examining the TCP reset message to see if it is intended for a device external to the home network's subnet. Similar to FIG. 4 step 408, this determination is made by comparing the destination IP address of the TCP reset message to the home network's subnet address. The module also determines if the original TCP request message passed through the gateway router by examining, in step 516, the TCP-port-forwarding table. Specifically, the table is examined to determine if there is an IP address/port-number table-entry that matches the IP address/port-number of the local PC that generated the TCP reset message (i.e., is there an entry that maps to the local PC).

If either of steps 514-516 does not hold true, operation proceeds back to step 506. However, if each condition holds true, a port forwarding misconfiguration may be present (as shown by step 518) and operation proceeds to step 520 where the passive monitor analysis module notifies the administration management system 240 of the condition by storing in network information database 246 the IP address and port-number of the TCP-port-forwarding table-entry in question, a current timestamp, and a customer-ID. Operation then proceeds back to step 504.

With respect to monitored messages that are determined to be ICMP messages (step 510), operation proceeds to steps 522 and 524 where the “type” field of the ICMP header is examined to determine if it is set to “destination unreachable” and where the “error-code” field of the header is examined to determine if it is set to “port unreachable,” respectively. If either condition is not true, operation proceeds back to step 506. However, if both conditions are true, a determination can be made that there is misconfiguration either with the local PC (i.e., the application is not executing) or with the gateway router (i.e., a port forwarding error). Similar to steps 514 and 516, the module next determines in steps 526 and 528 whether the original UDP request message that triggered the detected ICMP message passed through the gateway router. (Note in particular for step 528 that the module determines if the local PC that generated the ICMP message maps to an entry in the UDP-port-forwarding table. Here, the IP address and port-number of the local PC can be obtained from the source IP address of the ICMP message and from the ICMP message payload.) If either condition is not true, operation proceeds back to step 504. However, if both conditions are true, operation proceeds to steps 518 and 520, where the administration management system 240 is notified of a possible port forwarding errant condition.

Reference will now be made to the active stimuli analysis agent 224 in greater detail. As described above, the active stimuli analysis agent probes network elements and/or software applications for a response and as such, examines network devices/applications from the standpoint of how other network devices will interact with them. Similar to above, this agent comprises a plurality of modules 230. Several exemplary active stimuli analysis modules are now described.

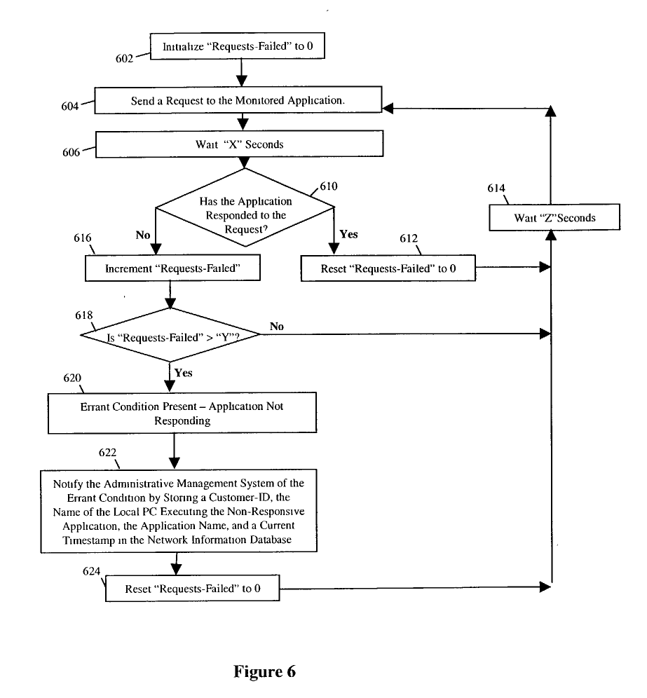

A first exemplary module is one that monitors applications executing within home network 202. Assume for example, a consumer configures a server application, such as a Web or file server, on a PC 208. Although the server application may appear to be properly configured from the standpoint of the PC, the application may not properly operate from the network perspective. Similarly, server applications can crash with the crash going undetected by the consumer. An agent module that can assist in detecting these types of issues is shown in FIG. 6. In this example, the module periodically sends a service request to an application and waits for a response. If no response is received after several requests, an alert is sent to administrative management system 240 indicating a possible errant condition. Several modules of this type may be executing within the active stimuli analysis agent, each monitoring a different application. Also, the exact format of any given request is in accordance with the type of application being monitored (e.g., a module monitoring a Web server may use http requests). Finally, the applications that are monitored (i.e., which modules are executing) are based on configuration information obtained from the initialization database 244

Beginning with step 602, the module first initializes a variable, “requests-failed,” to zero, which variable specifies the number of consecutive times an application has failed to respond to a request. In step 604, the module then sends a request to the monitored application, which request is in accordance with the application. The module then waits, in step 606, for “X” seconds for a response from the application. In step 610, a determination is made as to whether the application responded to the request. If a response has been received, operation proceeds to step 612 where the module resets “requests-failed” to zero, and then waits “Z” seconds (in step 614), before sending another request in step 604. However, if the application did not respond, operation proceeds from step 610 to step 616, where “requestsfailed” is incremented. Operation then proceeds to step 618 where “requests-failed” is analyzed to determine if the application has failed to respond to more than “Y” consecutive requests. If fewer than “Y” failures have occurred, operation proceeds to steps 614 and 604, where the module waits “Z” seconds and then sends another request. However, if the application has failed to respond to over “Y” consecutive requests, an errant condition is present, specifically, the application is not responding (as shown by step 620). Here, operation proceeds to step 622 where the module notifies the administrative management system 240 of the condition by storing in network information database 246 a customer-ID, name of the PC executing the non-responsive application, the application name, and a current timestamp. Finally, operation proceeds to steps 624, 614, and 604, where the module resets “requests-failed” to zero, waits “Z” seconds, and then sends another set of requests messages to the application.

A second exemplary module is one that monitors network devices executing within the network. Similar to applications, a network device may appear to be properly configured but fail to properly operate from the network perspective or may have crashed. For example, assume the local PCs are configured to obtain boot information, including an IP address, from a DHCP server. If this procedure fails, the PC may boot but fail to properly connect to the network. An agent module similar to the one described in FIG. 6 can assist in detecting network devices that have network connection issues, that have crashed, etc. Note that network devices can be accessed using standard network utilities, such as “ping.” Similar to above, if a network element fails to respond to consecutive requests, the module notifies the administrative management system 240 of the condition by storing in the network information database 246 the customer-ID, the non-responsive PC, and a current timestamp.

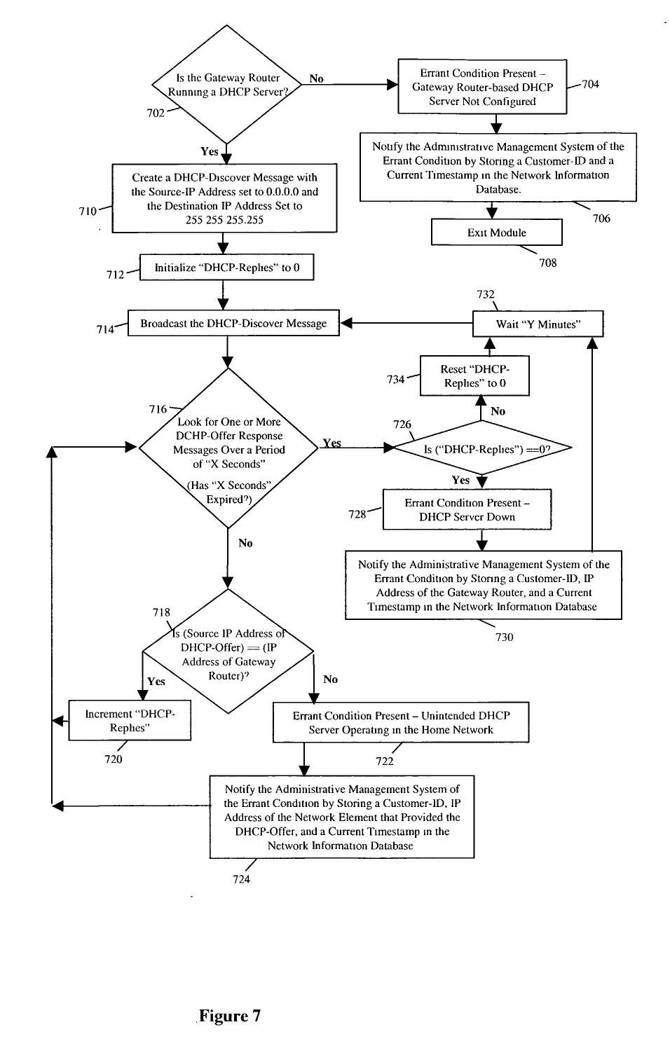

A third exemplary module is one that monitors a DHCP server in home network 202. As mentioned earlier, gateway routers are now configured with DHCP server capabilities that can be used to configure/boot the network devices. If this server incorrectly operates/crashes/is unreachable, the local devices will fail to boot. Boot/configuration issues can also arise if more than one DHCP server is active in the home network. For example, a PC can be also act as a DHCP server. Assuming a consumer wishes to only use the gateway router-based DHCP server, a network device may inadvertently use the PC-based DHCP server and thereby receive incorrect configuration information. Specifically, a network device may first broadcast a DHCP-Discover message looking for available DHCP servers on the home network. Both the gateway and PC-based DHCP servers will respond to this request with the network device then choosing one of the servers from which to obtain its configuration parameters. If the network device chooses the PC-based DHCP server, it may receive invalid configuration information. An agent module that can assist in detecting a crashed/misconfigured/unreachable DHCP server and multiple servers on the same network is shown in FIG. 7. In this example, the module assumes the gateway router is the intended DHCP server and periodically broadcasts DHCP-Discover messages to this server. Based on the responses, the module determines if there are multiple DHCP servers on the home network and/or whether the gateway router-based DHCP server is down/etc.

Specifically, in step 702 the module first determines if the gateway router is configured to run a DHCP server, which information can be obtained from the gateway router through standard interfaces. If the gateway router is not configured to run a DHCP server, an errant condition is present (as shown by step 720) and operation proceeds to step 706 where the module notifies the administrative management system 240 of the condition by storing in the network information database 246 a customer-ID and a current timestamp. Operation then proceeds to step 708, where the module exists.

However, if the gateway router is configured to run a DHCP server, the module proceeds to steps 710 and 712 where it creates a DHCP-Discover message (with the source IP address set to 0.0.0.0 and the destination IP address set to 255.255.255.255) and initializes a variable “DHCP-replies” to zero.

In step 714, the module then broadcasts the DHCP-Discover message and beginning with step 716, looks for DHCP-Offer response messages over a period of “X” seconds. If a DHCP-offer response is received in step 716, operation proceeds to step 718 where the message is analyzed to determine if the DHCP-offer came from the gateway router, which determination can be made by comparing the source IP address of the DHCP-offer message with the gateway router's assigned IP address on the home network. If the DHCP-offer message came from the gateway router (i.e., the DHCP server is properly operating), operation proceeds to step 720 where the “DHCP-replies” variable is incremented, indicating that the DHCP server is properly operating. However, if in step 718 the DHCP-offer message did not come from the gateway router, an errant condition is present, specifically, an unintended DHCP server is operating in the home network (as shown by step 722) and operation proceeds to step 724 where the module notifies the administrative management system 240 of the condition by storing in the network information database 246 the IP address of the network device that provided the DHCP-offer message, a current timestamp, and a customer-ID. Regardless of whether the DHCP-offer message came from the gateway router or an unintended DHCP server, operation then proceeds from step 720/724 back to step 716 where the module looks for additional DHCP-offer messages during the “X” second period.

Once “X” seconds has expired in step 716, the module stops looking for DHCP-offer messages and proceeds to step 726 where a determination is made as to whether the gateway router-based DHCP server ever sent a DHCP-offer message (i.e., does “DHCP-replies equal zero). If the server never responded, an errant condition is present, specifically, the DHCP server is down/etc. (as shown by step 728) and operation proceeds to step 730 where the module notifies the administrative management system 240 of the condition by storing in the network information database 246 the IP address of the gateway router, a current timestamp, and a customer-ID. Operation then proceeds to step 732 where the module waits “Y” minutes and then broadcasts another DHCP-discover message (step 714) repeating the process. However, if in step 726 it is determined that the DHCP server did respond with a DHCP-offer message, “DHCP-replies” is reset to zero (step 734) and operation again proceeds to step 732 where the module waits “Y” seconds and then repeats the process.

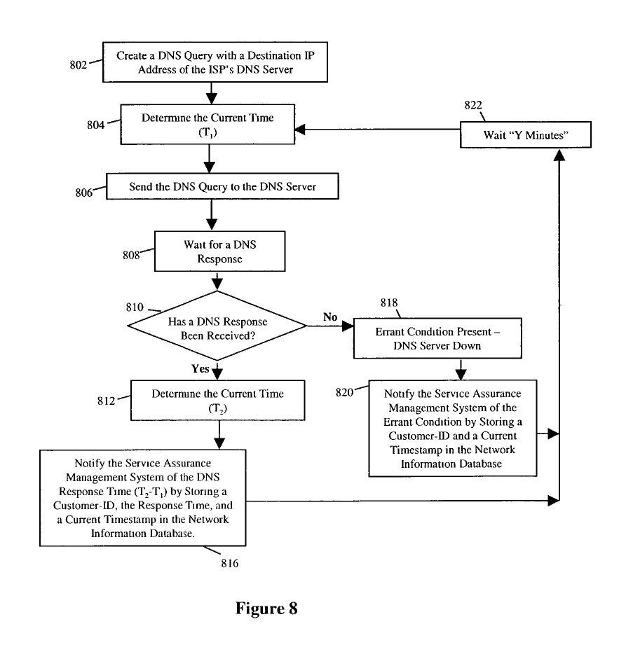

A final exemplary active stimuli analysis module is one that monitors performance issues in the home network/external network. Specifically, consumers can experience performance issues (such as network delays) in accessing the external network and it is not readily apparent if the issue exists in the home network or the external network. An agent module that can assist in diagnosing/detecting this type of problem is shown in FIG. 8. In this example, the module periodically sends a DNS (domain name system) request to the ISP's DNS server, for example, and measures the time it takes to get a response. The response time is then recorded at the administrative management system 240 in the network information database 246. Advantageously, by having such response times from multiple home networks, an ISP administrator can compare the response times and determine if there is a performance issue specific to a certain consumer or a performance issue specific to a set of consumers, thereby indicating an issue with the ISP's network.

Specifically, in step 802 the module first creates a DNS query using the IP address of the ISP's DNS server. In step 804, the module records the current time (T₁) and then sends the query to the server (step 806). The module then waits for a DNS response (step 808) and if no response is received (step 810), an errant condition is present, specifically, the DNS server is down (as shown by step 818). Here, operation proceeds to step 820 where the module notifies the administrative management system 240 of the condition by storing in network information database 246 a current timestamp and a customer-ID. Operation then proceeds to step 822 where the module waits “Y” minutes and then repeats the process. However, if in step 810 a DNS response is received, the module records the current time (T₂) and then notifies the administrative management system 240 of the network performance by storing in the network information database 246 the DNS response time (T₂-T₁), a current timestamp, and a customer-ID. Operation then proceeds to step 822 where the module waits “Y” minutes and then repeats the process.

The above-described embodiments of our invention are intended to be illustrative only. Numerous other embodiments may be devised by those skilled in the art without departing from the spirit and scope of our invention.

### Table of Acronyms

ARP: Address Resolution Protocol

DHCP: Dynamic Host Configuration Protocol

DNS: Domain Name System

ICMP: Internet Control Message Protocol

IP: Internet Protocol

ISP: Internet Service Provider

HTTP: Hypertext Transfer Protocol

NAT: Network Address Translation

PC: Personal Computer

TCP: Transmission Control Protocol

UDP: User Datagram Protocol

We claim:

1. A system for detecting errant conditions affecting a home network by considering end-to-end information flows within the home network, said system comprising:
a monitor analysis agent that monitors the home network and gathers monitored communications,
a stimuli analysis agent that stimulates the home network and that gathers responses to said stimuli, and
means for analyzing said monitored communications and said responses in order to detect errant conditions affecting the home network.

2. The system of claim 1 further comprising a configuration inspection analysis agent wherein said configuration inspection analysis agent determines home network configuration information and wherein said analyzing means uses said configuration information to detect said errant conditions.

3. The system of claim 1 further comprising means for storing said detected errant conditions and all or part of said gathered communications and said gathered responses.

4. The system of claim 1 wherein the monitor and stimuli analysis agents are located within the home network and wherein said analyzing means includes said monitor and said stimuli analysis agents and means external to the home network.

5. The system of claim 4 wherein said analyszing means external to the home network services a plurality of monitor and stimuli analysis agents within a plurality of home networks.

6. The system of claim 1 wherein said monitor analysis agent monitors communications flowing among devices comprising the home network and among the home network devices and devices comprising an external network, and wherein said stimuli analysis agent stimulates the home network devices and the external network devices.

7. The system of claim 1 wherein said monitor analysis agent and said stimuli analysis agent each comprises a plurality of analysis modules wherein each module is directed at gathering monitored communications or gathering stimuli responses for a particular errant condition.

8. The system of claim 7 wherein the plurality of modules reside within one or more network devices of the home network.

9. The system of claim 7 further comprising an initialization database and wherein said monitor analysis agent and said stimuli analysis agent access said initialization database to determine which of said plurality of analysis modules to execute.

10. The system of claim 1 wherein said monitor analysis agent uses ARP (address resolution protocol) cache poisoning in order to monitor the home network communications.

11. The system of claim 1 wherein the home network comprises a plurality of network devices and applications and wherein said stimuli analysis agent stimulates the network devices and applications for said responses.

12. The system of claim 1 wherein said stimuli agent stimulates a device in a network external to the home network in order to detect performance related errant conditions in the external network and the home network.

13. The system of claim 1 wherein said detected errant conditions include configuration issues, failed devices, failed applications, and performance problems.

14. A method for detecting errant conditions affecting a home network, said method comprising the steps of:
monitoring end-to-end information flows within the home network,
stimulating the home network and gathering responses to said stimuli, and
analyzing said information flows and said stimuli responses in order to detect errant conditions affecting the home network.

15. The method of claim 14 further comprising the step of probing the home network to determine home network configuration information, and
wherein said analyzing step further comprises the step of using said network configuration information in conjunction with said information flows and said stimuli responses to detect said errant conditions.

16. The method of claim 14 further comprising the step of reporting said detected errant conditions to an administrator in order for the administrator to correct said errant conditions.

17. The method of claim 14 wherein said monitoring step monitors end-to-end information flows flowing among devices comprising the home network and among the home network devices and devices comprising an external network, and wherein said stimulating step stimulates the home network devices and the external network devices.

18. The method of claim 14 further comprising the step of periodically using ARP (address resolution protocol) cache poisoning in order to monitor the end-to-end information flows.

19. The method of claim 14 further comprising the step of periodically stimulating a device in a network external to the home network in order to detect performance related errant conditions.

20. A system for detecting errant conditions affecting a home network by considering the end-to-end information flows within the home network, said system comprising:
a monitor analysis agent that monitors the home network and that gathers and analyzes monitored communications in order to detect errant conditions,
a stimuli analysis agent that stimulates the home network and that gathers and analyzes responses to said stimuli in order to detect errant conditions, and
an administrative management system comprising means for storing and reporting the monitored and stimulated detected errant conditions.

21. The system of claim 20 wherein said administrative management system also includes means for analyzing said monitored communications and said stimuli responses.
